(19) United States
(12) Patent Application Publication
(10) Pub. No.: US 2009/0060285 A1
(43) Pub. Date: Mar. 5, 2009

(54) RATING INDIVIDUALS ON A VOLUNTARY BASIS USING LEGAL NON-DISCRIMINATORY CRITERIA

(76) Inventors: William W. McKelvey, Van Nuys, CA (US); William W. Cochran, Fort Collins, CO (US)

Correspondence Address: COCHRAN FREUND & YOUNG LLC, 2026 CARIBOU DR, SUITE 201, FORT COLLINS, CO, 80525, US

(21) Appl. No.: 12/139,601

(22) Filed: Jun. 16, 2008

Related U.S. Application Data
(63) Continuation-in-part of application No. 10/366,226, filed on Feb. 12, 2003, now abandoned.
(60) Provisional application No. 60/357,223, filed on Feb. 12, 2002.

(51) Int. Cl. G06K 9/00; G06Q 10/00

(52) U.S. Cl. 382/115; 705/7

(57) ABSTRACT

Disclosed is a system and method for generating security level ratings for individuals based upon background information of the individuals. The security level rating can be used by businesses to provide enhanced services and products. For example, airlines may offer A level flights for only those individuals having A level security ratings. Shortened security lines may be available to A level rated individuals. A wide range of information is collected on a voluntary basis. Collected information includes all information that does not violate discrimination laws. Since the information is provided voluntarily, the information does not violate privacy laws. Information provided by the individual is checked against various databases such as FBI, NIS, CIA, credit and other databases. Uniform standards for generating a security level rating are employed by the secure ID company. Security terminals are located at security checkpoints to check secure ID cards against identifying information provided by the individual such as retinal scans, voice scans and hand print scans.

### CROSS-REFERENCE TO RELATED APPLICATION

This application is a continuation-in-part of U.S. patent application Ser. No. 10/366,226 entitled “RATING INDIVIDUALS ON A VOLUNTARY BASIS USING LEGAL NON-DISCRIMINATORY CRITERIA,” by William W. McKelvey, et al., filed Feb. 12, 2003, which application was based upon U.S. Provisional Patent Application Ser. No. 60/357,223, entitled “RATING INDIVIDUALS ON A VOLUNTARY BASIS USING LEGAL NON-DISCRIMINATORY CRITERIA,” by William W. McKelvey, et al., filed Feb. 12, 2002. The entire contents of the above mentioned applications are hereby specifically incorporated herein by reference for all they disclose and teach.

### BACKGROUND OF THE INVENTION

The present invention pertains generally to security and prevention of terrorism and more particularly to a security rating system. As a result of the terrorist attacks on Sep. 11, 2001, security has become an important issue, especially in the business community. More precise methods of identifying individuals and tracking background and histories have become vitally important.

On the other hand, basic tenets of American society have prevented law enforcement and security officials in both the government and private sectors from obtaining information to insure a higher level of security. For example, laws prevent discrimination based on race, creed, color, national origin, age, sex, and in some localities, sexual preference. In addition, privacy laws have prevented the collection and dispersal of certain personal information.

A method and supporting system is therefore needed that will allow the collection and verification of security information in a non-discriminatory manner and that does not violate the legal privacy rights of individuals.

### SUMMARY OF THE INVENTION

The present invention overcomes the disadvantages and limitations of the prior art by providing a security system and method of collection and verification of security data in a legal non-discriminatory manner. The present invention is based upon a voluntary program in which individuals provide background information, identification information, and personal identifying information on a voluntary basis. Since the information is provided on a voluntary basis, rights of privacy are not violated. Further, importance information is collected so that a security rating can be generated for each individual, which can then be used to offer those individuals different types and levels of service and products. The information that is collected to generate a security rating is relevant information that does not fall into one of the seven areas of discrimination listed above. Hence, laws against discrimination are not violated.

The present invention may therefore comprise a method of identifying individuals and generating a security rating based upon legal nondiscriminatory information that is voluntarily provided by an individual comprising: collecting identification information and background information that is voluntarily provided by the individual wherein the background information is only limited to information that does not violate laws of discrimination; collecting identifying information from the individual on a voluntary basis; generating a security level rating based upon the background information; issuing an identification card to the individual; using security terminals to scan the security card and obtain identifying information from the individual and generating a comparison to determine if the security card matches the identifying information collected from the individual.

The present invention may further comprise the method of claim 1 further comprising: providing enhanced services to the individual based upon the security level rating of the individual.

The advantages of the present invention are that individuals can obtain a security rating and be offered enhanced services and products on a non-discriminatory basis and without violating any rights of privacy of the individual. For example, background information may be requested from the individual relating to an established credit history such as ownership of credit cards, payment of utilities, establishment of mortgages, etc., over a period of years, that establish a record of stability and presence within the United States for a period of time. Individuals would also voluntarily allow the security company to collect information from databases such as the Federal Bureau of Investigation (FBI), Central Intelligence Agency (CIA), National Security Agency (NSA), Immigration and Naturalization Service (INS), and other databases. Criminal records, information regarding suspected terrorism activities, and other information can be collected which the individual has voluntarily allowed to be collected so that privacy rights are not violated. Identification information is also voluntarily provided by the individual. These may include submission of passports, drivers' licenses, birth certificates, utility bills, Social Security cards, and other identification information used to establish the identity of the individual. Personal identifying information may also be provided by the individual. For example, the individual may be required to submit to the collection of DNA information, blood typing, retinal scans, fingerprinting, and hand printing, facial identification analysis, and other personal identifying information. In this manner, very accurate, personal identifying information can be associated with the identification information so that a secure system can be developed for identifying individuals in a highly reliable fashion.

Personal identification cards may also be issued to the individual that allow the individual certain rights and privileges based upon a security rating that is indicated on the card for that individual. Enhanced services and products can then be provided based upon the level of the security rating. For example, an airline may wish to offer flights to individuals having an A level security rating. The passengers on an A level airline flight could be assured that all of the other passengers on the flights, as well as the pilots and flight attendants, have an A level security rating. Airlines may charge a premium for the A level service. Similarly, employees may be hired or not hired based upon a security level rating. This is especially applicable to jobs in which security is of great importance such as in the airline industry, security companies, jobs in handling sensitive information, etc.

A security system can also be established to support enforcement of these security methods. Although a secure identification card can be provided, even the most secure cards can normally be counterfeited with sufficient effort. Hence, a physical security system can be established to check the personal identifying information against the card at key locations. For example, an airline may establish an express line for individuals holding these types of security cards. However, prior to entering the plane or at the security check point, the individual must place the identification card in a security checking machine that obtains the identification information from the card. The individual is then required to submit to the collection of personal identifying information such as a fingerprint scan, hand scan, a retinal scan, and/or a voice recognition scan, etc. to insure that the personal identifying information corresponds with the identification information provided on the card. Standard methods of collecting this data can be used such as hand print scanners, retinal scanners, and voice scanners. The security device that collects the personal identifying information and identification information can access a central database established by the security company in the same manner as an ATM machine. Alternatively, each local security machine will have a sufficient amount of storage to store data and download it from the central database so frequent users may have this comparison made at the local security machine.

### BRIEF DESCRIPTION OF THE DRAWINGS

FIG. 1 is a flow diagram of the overall process that may be used in accordance with the present invention.

FIG. 2 is a schematic block diagram of the security devices that may be used in accordance with the present invention.

### DETAILED DESCRIPTION OF THE INVENTION

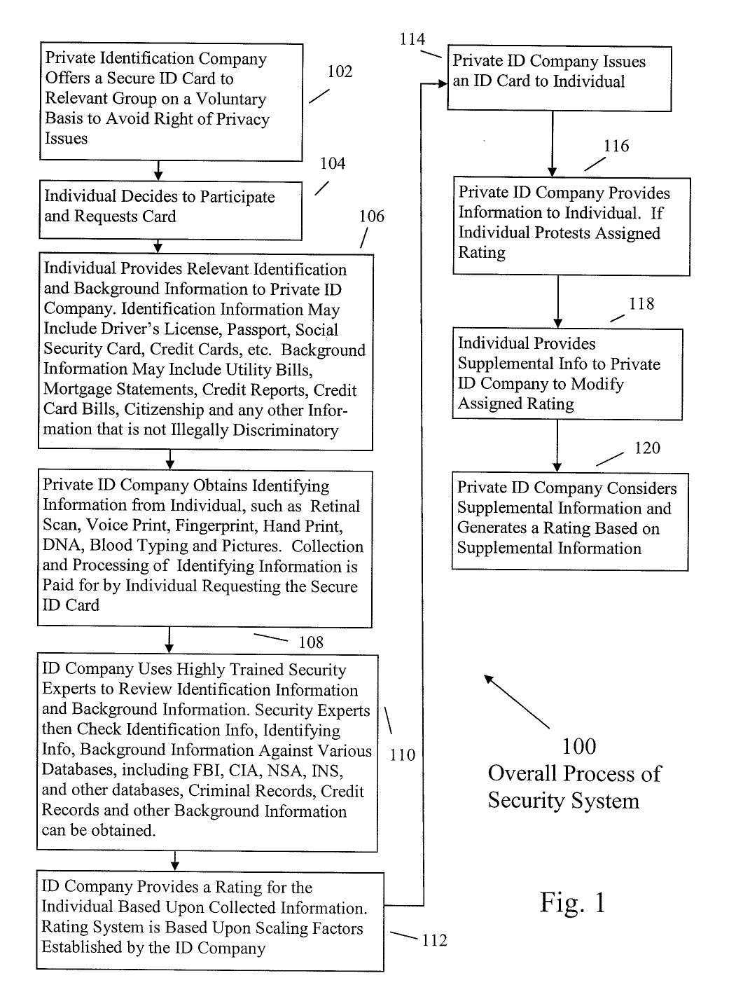

FIG. 1 is a flow diagram that illustrates the overall process at steps 100 that may be employed in accordance with the present invention. At step 102, a private identification company offers a secure identification card and identification system to a relevant group of individuals. The relevant group may comprise users of a particular service offered by a company, individuals seeking jobs in security-related businesses, individuals handling sensitive information, etc. For example, a particular airlines may wish to offer participation in the secure ID program to its frequency fliers, or to the general public who may wish to use the services of that airline. Similarly, an airline may require any job applicant to obtain a secure ID card and a secure ID rating from the private identification company prior to be considered for employment. The same may be true for flight attendants, security personnel, or any employee that works at an airport or foreign airlines in baggage handling, food preparation and service, pilots, etc. In addition, any of the transportation industries may also require participation by their employees such as train service, bus service, trucking companies, taxi service, etc. Private companies may also wish to use this service to rate employees who have access to sensitive information of the company as a method of establishing the stability and trustworthiness of employees who are handling sensitive information. In addition, owners of high-rise buildings may wish to restrict entry to only those individuals who have established a certain security level rating to establish a predetermined security level for a selected facility or service being provided by a business. For example, security stations may be established at the entrance to parking garages and lobbies of high-rise buildings that restrict entry to only those individuals having a predetermined security level rating or higher.

An advantage of providing this service is that these businesses can advertise that an established security level, such as a security level A rating, has been provided for a particular facility or service, which provides a certain degree of peace of mind to the occupants and users of a facility or service. Establishment of these security levels may also add to the prestige of a business. For example, a trucking company may proudly advertise that it is a security level B or security level B+, etc. business. Suppliers of facilities and services can also charge premium prices for facilities and services that have higher level ratings. For example, an airline may wish to provide several flights a day from San Francisco to Washington that are rated as A level flights and charge a premium price for those flights. Certain high-rise office buildings may wish to charge premium prices for rent by insuring that the facility only admits individuals having a B+rating.

The private identification company offers the secure ID card to any individual desiring to participate in the program on a voluntary basis. By offering the card on a voluntary basis, rights of privacy are clearly avoided. Requirements of employers to have potential employees participate in the program similarly does not violate privacy rights. Individuals can seek employment with other employers that do not require participation, and hence are not required to participate in the security program.

At step 104, the individual decides to participate in the security program and requests a secure ID card. At step 106, the individual provides relevant identification and background information to the private ID company. The identification information may include a driver's license, passport, Social Security card, credit cards, birth certificate, or other identification information to clearly establish the identity of the individual. Multiple documents may be required to guard against the falsification of the identify of the individual. Other measures may also be taken such as the private identification company contacting the individual to insure that the documents produced are not stolen identification information.

Background information may also be required by the private identification company. Background information may include information such as a history of payment of utility bills, mortgage statements, credit reports, credit card bills, a verified statement from a government official such as a police officer, judge, or other individual that establishes the identity and indicates the stability of the individual and that individual's presence in the United States for a period of time. An individual may also be required to provide information establishing that individual's birthplace as additional criteria that may be used in establishing a security rating. All of the background information that is required by the private identification company is non-discriminatory information that does not relate to any of the seven areas of legal discrimination.

At step 108, the private identification company obtains personal identifying information from the individual such as a retinal scan, voice print, fingerprint, hand print, DNA, blood typing, and facial characteristics that can be used by scanners to identify an individual. Collection and processing of the personal identifying information is paid for by the individual requesting the secure ID card. At step 10, the private identification company uses highly trained security experts to review the identification information submitted by the individual, as well as the background information. The security experts then check the identification information, identifying information and background information against various databases including databases made available by the FBI, CIA, NSA, INS, credit companies, local law enforcement records, etc. Criminal records, credit records, and other background information are then obtained and analyzed by the ID company. Personal identifying information is checked against personal identifying information of known terrorists and criminals to insure that there has been no falsification of information.

At step 112, the private identification company then generates a rating for the individual based upon the collected information. The rating system is based upon various scaling factors that are established by the ID company. For example, an individual having a Department of Energy Q clearance and a Department of Defense Top Secret security clearance, that was born in the USA, and has no felony charges or convictions, shows an extensive credit history, homeownership for a long period of time, and other similar factors, may obtain an A+rating. In that regard, home ownership could be valued for one point, extensive credit history, even though the individual does not have a high credit rating, may be valued for another point, being born in the USA may have a value of another point, a Department of Defense top secret security clearance may be valued for another point, and a Department of Energy clearance may be valued for another point. Felony charges may be valued for −1 point. A value of 5 points or more may result in an A+ rating for the individual, while a value of 4 points may be a B rating, 3 points could be a C rating, 2 points could be a D rating and 1 point could be an E rating. The value of each one of these criteria can be adjusted as desired. In addition, other criteria can also be used in the evaluation. Since all of the data that has been collected is non-discriminatory as determined by discrimination laws, any desired weighting factors or scaling factors can be used to establish a security level rating. For example, a certain number of points may be provided simply because the individual was born in the United States. Similarly, a certain number of points may be subtracted if an individual has a felony record.

At step 114, the private identification company issues a security card to the individual that indicates a predetermined rating on the card. The individual can then use the card with various businesses that recognize this card. At step 116, the user may be given the opportunity to protest the rating level that is provided. The private identification company may provide information to the user that was used to generate the rating of the security level. The user can then provide information to the private identification company to refute any of the information that is incorrect, in a manner similar to the way in which a credit rating score can be corrected at step 118. Established rules providing standards of fairness, that are uniformly applied by the private identification company, are used by the private identification company in the process of establishing the security level rating and for any protests by the user. As long as the method of establishing the security level rating does not violate any discrimination laws or privacy laws, and provides a uniform and fair manner of establishing the security level rating, the private identification company can eliminate liability for its actions.

At step 120, the private ID company considers the supplemental information and generates a rating based upon the original information and the supplemental information. This new rating may not differ from the original rating. The individual may continue to provide supplemental information which the private ID company may consider based upon a payment of a fee by the individual. These fees may escalate depending on the number of times the individual submits supplemental information within a predetermined period, such as one year.

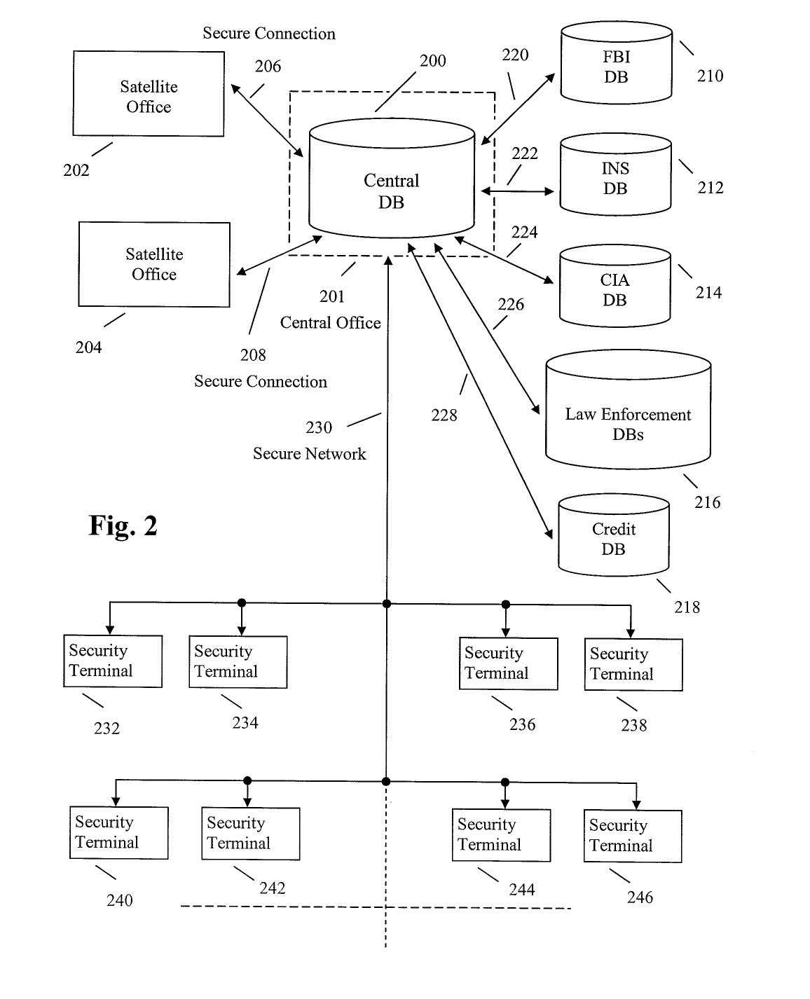

FIG. 2 is a schematic block diagram of one implementation of a security system that can be used in accordance with the present invention. As illustrated in FIG. 2, the secure ID company has a central database 200 that processes information from various sources and provides that information in accordance with the present invention. A number of satellite offices 202, 204 are connected to the central database 200 via secure connections 206, 208, respectively. These secure connections may be private networks or may be secure connections through the public switch telephone network. The satellite offices 202, 204 are offices that are established in various locales that may be visited by individuals that wish to obtain a security rating and a secure ID from the private ID company. For example, these satellite offices may be located in major airports, central locations in major cities, etc. Satellite offices can collect the identification information, identifying information and background information from individuals. The collection of this information will necessitate the user actually visiting the satellite office so that trained security experts can associate the identification information with the individual and collect the identifying information from the individual. This information is transmitted to the central database 200 which may be located in a central office.

As also illustrated in FIG. 2, the central database 200 is connected to various databases such as the FBI database 210, the INS database 212, the CIA database 214 and various law enforcement databases 216 and any other databases, such as credit databases 218, via secure connections 220, 222, 224, 226, 228. The central database 200 can then verify identification information, identifying information and background information of each individual, as well as collect additional background information, through access to the various databases and sources of information that may be used by the central database 200 located at the central office. The central database 200 may also apply the standardized rules for generating a security level rating for each individual after the information is verified, processed and otherwise checked as to authenticity. This information can then be transmitted via the secure connections 206, 208 to the satellite offices 202, 204. Depending upon the availability of the various databases which are accessed by the central database 200, the security level rating may be generated in a matter of a few minutes while the individual is still present in the satellite offices 202, 204. The satellite offices 202, 204 may then issue secure ID cards to the individual that indicate the security level rating of that individual and which contains identification information of the individual. Alternatively, secure IDs may only be issued by the central office 201 which are physically transmitted to the satellite offices 202, 204 to insure a higher level of security.

As also shown in FIG. 2, the central database 200 is connected to a secure network 230. The secure network is, in turn, connected to a series of security terminals 232, 234, 236, 238, 240, 242, 244, 246. These security terminals may be located at various locations, such as security checkpoints located in airport buildings, entrances to planes, entrances to highrise buildings, etc. The purpose of the security terminals is to check the secure ID that is issued by the secure ID company against the identifying information of the individual. The security terminals 232-246 are capable of accepting and scanning the secure ID card and also scanning the individual to obtain identifying information. For example, the security terminals 232-246 may be capable of scanning and reading holographic information identifying the individual, or other identification information, such as bar codes or printed names using optical character recognition techniques. The security terminals 232-246 also include scanners that physically scan the individual to obtain identifying information of that individual. For example, a retinal scan device may be used to scan and identify an individual by obtaining retinal identifying information. Similarly, voice scans and handprint scans may be obtained from the individual. The identifying information that is obtained by the security terminal by scanning the individual is then compared with the identification information obtained by scanning the secure ID card. The central database 200 may be accessed by the security terminals 232-246 via the secure network 230 and generate the comparison of the identification information scanned from the secure ID card and the identifying information that is scanned from the individual. If the comparison is favorable, the individual is allowed to pass through the security terminal. If it is unfavorable, security personnel may be summoned.

Each of the security terminals 232-246 may contain a large storage capacity for storing identifying information and identification information collected by previous users of the security terminal. In this fashion, comparisons can be made of the collected data at the local security terminal to increase the speed at which the local security terminal operates. The processes for carrying out these techniques are frequently used in ATM machines, gas pump credit card machines, etc. Such measures may be used with security terminals that are physically secure and cannot be tampered with by non-secure personnel.

The present invention therefore provides a unique method and system for obtaining and verifying information relating to individuals to identify those individuals. This information is gathered and obtained on a voluntary basis such that privacy laws are not violated. Further, highly relevant information can be collected relating to potential threats that an individual may pose since a wide range of information can be collected by the private identification company. In that regard, the information is only restricted by the seven areas of legal discrimination. Further, this information can be used to generate a security level rating for each individual that can be used to provide enhanced products and services to the individual. Different scaling criteria can be used depending on the different types of services and products that are provided.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A non-governmental system for identifying an individual and generating a security level rating for said individual based upon nondiscriminatory information comprising:
at least one satellite office for collecting identification information, biometric identifying information and security background information from said individual on a voluntary basis and from sources other than said individual, with permission from said individual, said security background information restricted to information that is not discriminatory and provides a record of stability of said individual;
a central office that is connected through secure connections to said satellite office to obtain said identification information, said security background information and said biometric identifying information from said satellite office, said central office further applying uniform security level rating rules that are not discriminatory to generate a security level rating for said individual based upon said security background information including said record of stability of said individual, and for generating information for production of a security card that includes said identification information and said security level rating;
at least one security terminal coupled to said central office via a secure network, said security terminal capable of collecting biometric identifying information from said individual and said identification information from said security card provided to said individual to determine if said biometric identifying information collected by said security terminal correctly identifies said user of said security card.

2. The system of claim 1 wherein said record of stability is selected from the group consisting of: utility bill records, mortgage statements, credit reports, credit card bills, verified statements from government officials and statements from judges.

3. The system of claim 1 wherein said security terminal is used to provide enhanced services to said individual.

4. The system of claim 1 wherein said security terminal is used to provide selected products to said individual.

5. A method of generating a security rating of an individual by a non-governmental agency comprising:
collecting identification information of said individual that is provided on a voluntary basis;
collecting personal identifying biometric information of said individual that is provided on a voluntary basis;
collecting security background information that is provided by said individual on a voluntary basis and from sources other than said individual with permission from said individual, said security background information being based upon said identification information and said personal identifying biometric information, said security background information restricted to information that is not discriminatory and provides a record of stability of said individual;
generating a security level rating based upon said identification information, security background information, including said record of stability of said individual, and said personal identifying biometric information using a uniform set of rules that do not violate discrimination laws.

6. The method of claim 5 further comprising:
issuing a security card to said individual that has said security level rating and said identification information stored on said card.

7. The method of claim 6 further comprising:
scanning said security card in a security terminal to retrieve said security level rating and said identification information.

8. The method of claim 7 further comprising:
collecting biometric information from a user of said security card at a security terminal;
comparing said biometric information collected at said security terminal with said personal identifying biometric information associated with said identification information stored on said card to determine if said user of said card is a correct user;
comparing said security level rating on said card with said security level rating of said individual.

9. The method of claim 8 wherein said process of collecting security background information that provides a record of stability of said individual comprises:
collecting security background information that is selected from the group consisting of: utility bills, mortgage statements, credit reports, credit card bills, verified statements from government officials and statements from judges.
